(19) United States
(12) Patent Application Publication
(10) Pub. No.: US 2006/0051502 A1
(43) Pub. Date: Mar. 9, 2006

(54) Methods for applying abrasive and environment-resistant coatings onto turbine components

(76) Inventors: Yiping Hu, Greer, SC (US); William F. Hehmann, Greer, SC (US); Federico Renteria, Greenville, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/936,925

(22) Filed: Sep. 8, 2004

(51) Int. Cl. B05D 1/12

(52) U.S. Cl. 427/180

(57) ABSTRACT

A method for coating a surface of a turbine component with an environment-resistant and wear-resistant material includes the step of cold gas-dynamic spraying a powder material on the turbine component surface, the powder material comprising a mixture of MCrAlY powder and an abrasive powder such as cubic boron nitride, diamond, carbides, and oxides, with M being selected from Ni, Co and mixtures thereof. The method can further include the step of heat treating the turbine component after the cold gas-dynamic spraying. Thus, the present invention can be employed to greatly improve the performance and the durability of HPT components, and dramatically prolong their service life.

### TECHNICAL FIELD

The present invention relates to turbine engine components that function in high temperature and high pressure environments. More particularly, the present invention relates to methods for coating turbine engine components such as turbine blades to prevent erosion due to wear, corrosion, oxidation, thermal fatigue, foreign particle impact, and other hazards.

### BACKGROUND

Turbine engines are used as the primary power source for various kinds of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, electrical generators, or other devices.

Since turbine engines provide power for many primary and secondary functions, it is important to optimize both the engine working life and the operating efficiency. One way that the engine efficiency can be optimized is to prevent leakage of expanding hot air from the engine. Minimizing a gap that is between the turbine blades and the turbine section shroud surrounding the blades prevents the hot air from leaking through the gap. One way to minimize the gap is to grind and otherwise machine the blade tips so the installed blades span a diameter that closely matches the shroud inner diameter. However, grinding the blades often removes platinum aluminide or an overlay coating normally disposed at the blade tip. As a result, the bare blade alloy is directly exposed to the harsh environment during engine operation, and is consequently susceptible to degradation due to corrosion, oxidation, erosion, thermal fatigue, wear, and foreign particle impacts. A worn or damaged blade creates a loss in efficiency during engine operation because degraded blades create gaps between the blade and the surrounding shroud to lose power efficiency.

Hence, there is a need for methods and materials for coating turbine engine components such as the turbine blades. There is a particular need for abrasive and environment-resistant coating materials that will improve turbine component's durability, and for efficient and costeffective methods of coating the components with such materials.

### BRIEF SUMMARY

The present invention provides a method for coating a surface of a turbine component with a powder mixture of MCrAlY and an abrasive. The method comprises the step of cold gas-dynamic spraying a powder material on the turbine component surface, the powder material comprising a mixture of MCrAlY powder and an abrasive powder such as cubic boron nitride (CBN) and diamond, M being selected from Ni, Co and mixtures thereof. In one embodiment, the method further comprises the step of heat treating the turbine component after the cold gas-dynamic spraying.

Other independent features and advantages of the preferred methods will become apparent from the following detailed description, taken in conjunction with the accompanying drawings which illustrate, by way of example, the principles of the invention.

### BRIEF DESCRIPTION OF THE DRAWINGS

FIG. 1 is a schematic view of an exemplary cold gas-dynamic spray apparatus in accordance with an exemplary embodiment;

FIG. 2 is a perspective view of an exemplary turbine blade in accordance with an exemplary embodiment; and

FIG. 3 is a flow diagram of a coating method in accordance with an exemplary embodiment.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides an improved method for coating high pressure turbine (HPT) components such as turbine blades to prevent degradation due to corrosion, oxidation, thermal fatigue, foreign particle impact, wear, and other hazards. The method utilizes a cold gas-dynamic spray technique to coat HPT component surfaces with mixtures of MCrAlY alloys and abrasive materials. A heat treatment may follow the cold gas-dynamic spray technique to homogenize the coating microstructure, and also to improve bond strength, environment-resistant, and wear-resistant properties. These coatings can be used to improve the durability of components such as turbine blades and vanes against objects, materials, and other factors that can cause erosion, oxidation, corrosion, thermal fatigue cracks, and impact damage, to name several examples.

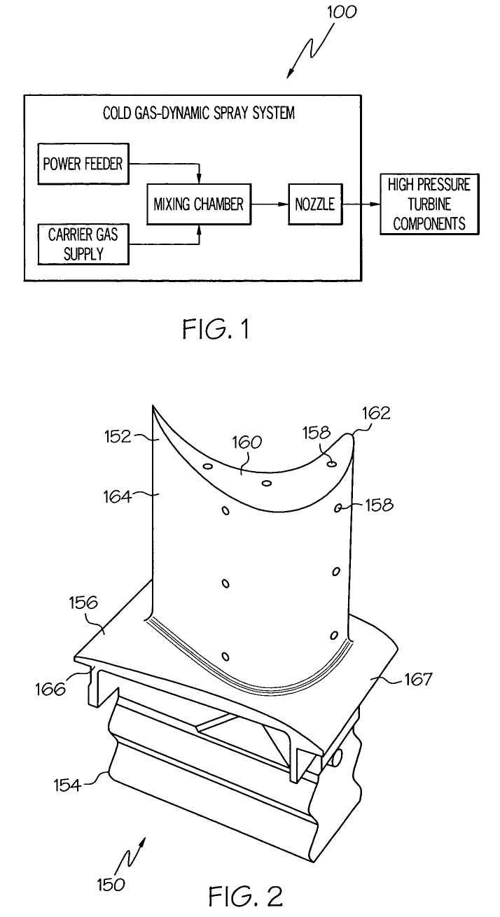

Turning now to FIG. 1, an exemplary cold gas-dynamic spray system 100 is illustrated diagrammatically. The system 100 is illustrated as a general scheme, and additional features and components can be implemented into the system 100 as necessary. The main components of the cold-gas-dynamic spray system 100 include a powder feeder for providing powder materials, a carrier gas supply (typically including a heater) for heating and accelerating powder materials, a mixing chamber and a convergent-divergent nozzle. In general, the system 100 transports the MCrAlY and abrasive powder mixtures with a suitable pressurized gas to the mixing chamber. The particles are accelerated by the pressurized carrier gas, such as helium or nitrogen, through the specially designed nozzle and directed toward a targeted surface on the turbine component. When the particles strike the target surface, converted kinetic energy causes plastic deformation of the particles, which in turn causes the particles to form a bond with the target surface. Thus, the cold gas-dynamic spray system 100 can bond the powder materials to an HPT component surface and thereby strengthen and protect the component.

The cold gas dynamic spray process is referred to as a “cold gas” process because the particles are mixed and applied at a temperature that is well below their melting point. The kinetic energy of the particles on impact with the target surface, rather than particle temperature, causes the particles to plastically deform and bond with the target surface. Therefore, bonding to the HPT component surface takes place as a solid state process With insufficient thermal energy to transition the solid powders to molten droplets.

According to the present invention, the cold gas-dynamic spray system 100 applies a high-strength mixture of MCrAlY alloy and abrasive materials that are difficult to weld or otherwise apply to HPT component surfaces. The cold gas-dynamic spray system 100 can deposit multiple layers of differing powder mixtures, density and strengths. The system 100 is typically operable in an ambient external environment.

The cold gas-dynamic spray system 100 is useful to spray a variety of MCrAlY and abrasive material mixtures. In an exemplary embodiment, the MCrAlY powder includes one or more alloys with M being Ni, Co, or combinations of Ni and Co. Exemplary abrasive materials include diamond, cubic boron nitride (CBN), and various carbides and oxides. The MCrAlY/abrasive powder mixture percentage ratio is between about 90/10 and about 20/80 by weight.

As previously mentioned, the cold gas-dynamic spray process can be used to provide a protective coating on a variety of different turbine engine components. For example, the turbine blades in the hot section of a turbine engine are particularly susceptible to wear, oxidation and other degradation. One exemplary turbine blade that is coated according to the present invention is made from high performance Ni-based superalloys such as IN738, IN792, MarM247, Rene 80, Rene 125, Rene N5, SC 180, CMSX 4, and PWA 1484.

Turning now to FIG. 2, a blade 150 that is exemplary of the types that are used in turbine engines is illustrated, although turbine blades commonly have different shapes, dimensions and sizes depending on gas turbine engine models and applications. The blade 150 includes several components that are particularly susceptible to erosion, wear, oxidation, corrosion, cracking, or other damage, and the process of the present invention can be tailored to coat different blade components. Among such blade components is an airfoil 152. The airfoil 152 includes a concave face and a convex face. In operation, hot gases impinge on the concave face and thereby provide the driving force for the turbine engine. The airfoil 152 includes a leading edge 162 and a trailing edge 164 that encounter air streaming around the airfoil 152. The blade 150 also includes a tip 160. In some applications the tip may include raised features commonly known as squealers. The turbine blade 150 is mounted on a non-illustrated turbine hub or rotor disk by way of a dovetail 154 that extends downwardly from the airfoil 152 and engages with a slot on the turbine hub. A platform 156 extends longitudinally outwardly from the area where the airfoil 152 is joined to the dovetail 154. A number of cooling channels desirably extend through the interior of the airfoil 152, ending in openings 158 in the surface of the airfoil 152.

As mentioned previously, the process of the present invention can be tailored to fit the blade's specific needs, which depend in part on the blade component where degradation has occurred. For example, the airfoil tip 160 is particularly subject to degradation due to oxidation, erosion, thermal fatigue and wear, and the cold gas dynamic spray process is used to apply the mixture of MCrAlY alloy and abrasive materials onto a new or refurbished airfoil tip 160. The coating thickness ranges from 0.002 inch to 0.100 inch. Following the cold spraying process, the tip 160 may be machined to bring the tip 160 to the designed dimensions.

As another example, degradation on the airfoil leading edge 162 can be prevented using the cold gas-dynamic spray process. The leading edge 162 is subject to degradation, typically due to erosion and foreign particle impact. In this application, the cold gas dynamic spray process is used to apply materials that protect a new or refurbished leading edge 162. Again, this can be done by cold gas-dynamic spraying the mixture of MCrAlY alloy and abrasive materials onto the leading edge 162. The cold spraying may be followed by dimensional restoration and post-spray processing.

It is also emphasized again that turbine blades are just one example of the type of turbine components that can be coated using a cold gas-dynamic spray process. Vanes, shrouds, combustion liners, fuel nozzles and other turbine components can be coated in the same manner according to the present invention.

A variety of different systems and implementations can be used to perform the cold gas-dynamic spraying process. For example, U.S. Pat. No. 5,302,414, entitled “Gas-Dynamic Spraying Method for Applying a Coating” and incorporated herein by reference, describes an apparatus designed to accelerate materials having a particle size of between 5 to about 50 microns, and to mix the particles with a process gas to provide the particles with a density of mass flow between 0.05 and 17 g/s-cm². Supersonic velocity is imparted to the gas flow, with the jet formed at high density and low temperature using a predetermined profile. The resulting gas and powder mixture is introduced into the supersonic jet to impart sufficient acceleration to ensure a particle velocity ranging between 300 and 1200 m/s. In this method, the particles are applied and deposited in the solid state, i.e., at a temperature which is considerably lower than the melting point of the powder material. The resulting coating is formed by the impact and kinetic energy of the particles which gets converted to high-speed plastic deformation, causing the particles to bond to the surface. The system typically uses gas pressures of between 5 and 20 atm, and at a temperature of up to 750° F. As non limiting examples, the gases can comprise air, nitrogen, helium and mixtures thereof. Again, this system is but one example of the type of system that can be adapted to cold spray powder materials to the target surface.

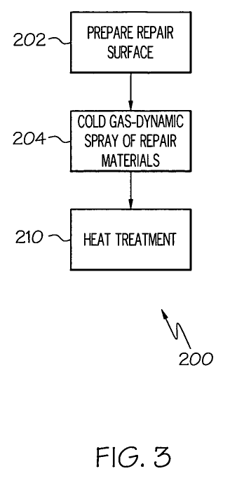

Turning now to FIG. 3, an exemplary method 200 is illustrated for coating and protecting turbine blades, vanes, and other HPT components. This method includes the cold gas-dynamic spray process described above, and also includes a diffusion heat treatment. As described above, cold gas-dynamic spray involves “solid state” processes to effect bonding and coating build-up, and does not rely on the application of external thermal energy for bonding to occur. However, thermal energy is provided after bonding has occurred since thermal energy promotes formation of the desired microstructure and phase distribution for the cold gas-dynamic sprayed MCrAlY/abrasive materials, and consequently consolidates and homogenizes the MCrAlY/abrasive coating.

The first step 202 comprises preparing the surface on the turbine component. For example, the first step of preparing a turbine blade can involve pre-machining, degreasing and grit blasting the surface to be coated in order to remove any oxidation and dirty materials.

The next step 204 comprises performing a cold gas-dynamic spray of the mixture of MCrAlY and abrasive materials on the turbine component. As described above, in cold gas-dynamic spraying, particles at a temperature below their melting temperature are accelerated and directed to a target surface on the turbine component. When the particles strike the target surface, the kinetic energy of the particles is converted into plastic deformation of the particle, causing the particle to form a strong bond with the target surface. The spraying step includes directly applying the MCrAlY/abrasive powder mixture to turbine components in the turbine engine. For example, material can be applied to surfaces on turbine blades and vanes in general, and particularly to blade tips and leading edges, for example.

The spraying step 204 generally returns the component to its desired dimensions, although additional machining can be performed if necessary. In an exemplary embodiment, the cold spray coating ranges in thickness between about 0.002 and about 0.100 inch after rotor machining.

The next step 206 involves performing a diffusion heat treatment on the coated turbine component. A diffusion heat treatment can homogenize the microstructure of coating and greatly improve bonding strength between the coating and the substrate. According to an exemplary embodiment, a turbine blade, vane, or other component is heated for about two to about eight hours at a temperature between about 1900 and about 2050° F. to consolidate and homogenize the abrasive and environment-resistant coating.

The present invention thus provides an improved method for coating turbine engine components. The method utilizes a cold gas-dynamic spray technique to prevent degradation in turbine blades and other turbine engine components. These methods can be used to optimize the operating efficiency of a turbine engine, and to prolong the operational life of turbine blades and other engine components.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for coating a surface of a turbine component with an environment-resistant and wear-resistant material, comprising the step of:
forming an abrasive coating by cold gas-dynamic spraying a powder material on the turbine component surface, the powder material comprising a mixture of:
MCrAlY powder, with M being selected from Ni, Co and mixtures thereof, and
an abrasive powder being selected from the group consisting of cubic boron nitride, diamond, carbides, and oxides; and
heating the turbine component after forming the abrasive coating at a temperature sufficiently high to consolidate and homogenize the abrasive coating.

2. The method of claim 1, wherein the turbine component is a turbine blade.

3. The method of claim 2, wherein the surface of the turbine blade surface being sprayed is an airfoil tip surface.

4. The method of claim 2, wherein the surface of the turbine blade surface being sprayed is an airfoil leading edge surface.

5. (canceled)

6. The method of claim 1, wherein the heating step is performed between about two and about eight hours.

7. The method of claim 1, wherein the heating step is performed at a temperature between about 1900 and about 2050° F.

8. The method of claim 1, further comprising the step of:
machining the turbine component to bring the sprayed powder material to a thickness between about 0.002 and about 0.100 inch.

9. The method of claim 1, wherein the mixture of MCrAlY powder/abrasive powder is at a percentage ratio between about 90/10 and about 20/80 by weight.

10. A method for coating a surface of a turbine component with an environment-resistant and wear-resistant material, comprising the step of:
forming an abrasive coating by cold gas-dynamic spraying a powder material on the turbine component surface, the powder material comprising a mixture of:
MCrAlY powder, with M being selected from Ni, Co and mixtures thereof, and
an abrasive powder being selected from the group consisting of carbides, and oxides; and
heat treating the turbine component at a temperature sufficiently high to consolidate and homogenize the abrasive coating after the cold gas-dynamic spraying.

11. The method of claim 10, wherein the turbine component is a turbine blade.

12. The method of claim 11, wherein the surface of the turbine blade surface being sprayed is an airfoil tip surface.

13. The method of claim 11, wherein the surface of the turbine blade surface being sprayed is an airfoil leading edge surface.

14. (canceled)

15. The method of claim 10, wherein the heat treatment is performed between about two and about eight hours.

16. The method of claim 10, wherein the heat treatment is performed at a temperature between about 1900 and about 2050° F.

17. The method of claim 10, further comprising the step of:
machining the turbine component to bring the sprayed powder material to a thickness between about 0.002 and about 0.100 inch.

18. The method of claim 10, wherein the mix of MCrAlY powder/abrasive powder is at a percentage ratio between about 90/10 and about 20/80 by weight.
